(19) United States
(12) Patent Application Publication
(10) Pub. No.: US 2002/0174733 A1
(43) Pub. Date: Nov. 28, 2002

(54) POINTER INSTRUMENT

(76) Inventor: GUIDO ROTHERMEL, BABENHAUSEN (DE)

Correspondence Address: MARTIN A FARBER, 866 UNITED NATIONS PLAZA, SUITE 473, NEW YORK, NY, 10017

(21) Appl. No.: 09/405,028

(22) Filed: Sep. 24, 1999

(30) Foreign Application Priority Data
Sep. 28, 1998 (DE) 198 44 187.8
Oct. 20, 1998 (DE) 198 48 219.1

(51) Int. Cl. G01D 7/02

(52) U.S. Cl. 73/866.3

(57) ABSTRACT

In a pointer instrument (1), a pointer (5) can be deflected by means of a pointer drive (9). For this purpose, the pointer (5) has a load-bearing body (4) that can pivot about a fixed axle (3). The fixed axle (3) serves at the same time to accommodate a central display (6). The pointer (5), designed as a pot pointer, is arranged so that it can pivot between a dial (7) and the axle (3) in an essentially common plane. As a result of the fixed axle (3), the pointer (5) is insensitive to oscillation or shaking and, at the same time, permits the central region of the pointer instrument (1) to be used for the display (6).

The invention relates to a pointer instrument, especially for a motor vehicle, having a pointer, a pointer drive for deflecting the pointer and having a dial, it being possible for measured values to be displayed in analog fashion on the dial.

Pointer instruments of the above type are used, for example, as tachometers or revolution counters in current motor vehicles. For the purpose of enhanced legibility it is desirable for the pointer instrument to have a relatively large diameter. The disadvantageous effect here is that the central inner region enclosed by a scale is swept over by a pointer flag, and is therefore available only to a restricted extend for further displays. It has to be ensured that the display is legible at any time, irrespective of the angular position of the pointer flag. Furthermore, there is a disadvantageous effect in that a pointer shaft deflecting the pointer flag passes through the central region of the pointer instrument. As a result, if large-area displays are used, especially LCD displays, an aperture for the pointer shaft has to be provided, which is associated with considerable production problems.

Embodiments of pointer instruments are also known in which a central aperture for the pointer shaft is avoided by the pointer flag being designed such that it is bent over twice and thus being firstly guided along behind the display in a central region and being visible to the viewer only in the edge region of the pointer instrument. An embodiment of this type necessitates a relatively long pointer which, as a result of vibrations such as are unavoidable in a motor vehicle, for example, likewise starts to oscillate. As a result, the action of reading the pointer instrument is made more difficult and an undesired, inferior impression is conveyed. A further disadvantage is that, in the event of any contact between the oscillating pointer and the display or the dial, it is possible for impairment to the calibration of the pointer instrument to occur.

The invention is based on the problem of configuring a pointer instrument of the type mentioned at the beginning in such a way that oscillations of the pointer can be avoided and, at the same time, the central region of the instrument can be used for further displays. At the same time, any restriction to the legibility by a pointer pivoted over the display is to be ruled out.

According to the invention, this problem is solved by the pointer being able to pivot about a fixed axle which, on a section inclined toward a viewer, bears a display. By this means, the central region, especially the end face of the non-moving axle, can be used for a display or a switching element and, at the same time, the length of the pointer can be reduced. At the same time, the moving mass is reduced, so that the pointer drive is relieved of load and, at the same time, a high setting speed is achieved. The diameter of the axle can be adapted optimally to the size of the desired display, the pointer instrument, by contrast with conventional pointer instruments which have a pointer shaft deflecting the pointer flag, being more dimensionally stable and thus less sensitive to external shaking or vibrations.

A particularly advantageous development of the invention is provided by the display being a liquid crystal display (LCD). As a result of the low overall height of an LC display, a pointer instrument designed in this way can be designed to be comparatively flat. This produces an arrangement which is compact and, in particular as a result of the low height of the axle which is thereby possible is extremely rigid and therefore insensitive. In addition, a large amount of information can easily be displayed with the aid of the LC display.

The pointer can have a pointer flag that can pivot about the axle. On the other hand, a development of the invention, in which the pointer has a rotationally symmetrical load-bearing body which can pivot about the axle, is particularly advantageous. This load-bearing body can be arranged rotatably so as to be visible to a viewer in an annular gap between the axle and the dial, and can have a pointer flag known per se or a marking applied to the surface of the load-bearing body. At the same time, the load-bearing body can be deflected directly without problems by means of the pointer drive, as a result of the rotationally symmetrical embodiment. For this purpose, the pointer drive may have, for example, a friction wheel or gearwheel which engages in a correspondingly shaped section of the load-bearing body.

A particularly favorable embodiment of the invention is also provided when the axle has a smaller diameter in a section that cannot be seen by the viewer than in a section which can be seen by the viewer. By this means, the bearing point required between the axle and the pointer can easily be covered by the section of the axle which bears the display, and can thus be arranged to be invisible to the viewer, outside his field of view. At the same time, this design makes a space-saving arrangement of the pointer drive or further elements possible, as a result of the rear section being tapered with respect to the visible region of the axle.

A particularly expedient embodiment of the invention is provided by the load-bearing body having a light-injection face on its side facing away from a viewer. By this means, simple and easy illumination of the pointer, and of a pointer flag that may be connected thereto, can be achieved. In particular, as a result of the comparatively large-area configuration of the light injection surface, energy-saving and reliable light-emitting diodes (LED) can also be used.

The pointer can be arranged to pivot in a plane which stands forward with respect to the display. On the other hand, a particularly clear embodiment of the invention is provided by the pointer and the dial being arranged in a common plane. By this means, reading errors as a result of different viewing angles can be prevented. At the same time, a compact and flat overall shape can be achieved, it being possible for a possible covering disk of the pointer instrument to be arranged directly in front of the dial and, as a result, for reflections to be ruled out. In addition, the display can also be arranged in the common plane. In this case, the pointer is of annular design, for example, and is inserted into a corresponding recess, so that the view of components of the pointer instrument located beneath is blocked.

A particularly beneficial development of the invention is also provided when the pointer instrument is designed so that it can be illuminated by means of an electroluminescent (EL) sheet. This enables the uniform and large-area illumination of the load-bearing body of the pointer, which is annular, for example. In this case, it is possible both for just the pointer flag or a marking or the entire load-bearing body to be illuminated. For this purpose, the EL sheet can radiate into the light-injection face or can be arranged directly on the pointer and be pivotable together with the latter.

A development of the invention is particularly advantageous as a result of the fact that the pointer can be deflected by the pointer drive by means of a belt drive. As a result, any transmission or vibrations or shaking from the pointer drive to the pointer can be reduced considerably. The pointer instrument can therefore be read easily, even under difficult operating conditions.

Another embodiment of the invention is particularly expedient in that the pointer drive is arranged laterally alongside the pointer. This allows a low overall height to be implemented with only a low requirement for space. Depending on the size of the load-bearing body, modifications are also conceivable in which the pointer drive engages on the inside of a pointer designed as a hollow body. In this case, the drive can also be integrated into the fixed axle at the same time.

The invention permits various embodiments. In order to illustrate its basic principal further, one of these embodiments is illustrated in the drawing and will be described below. In the drawing:

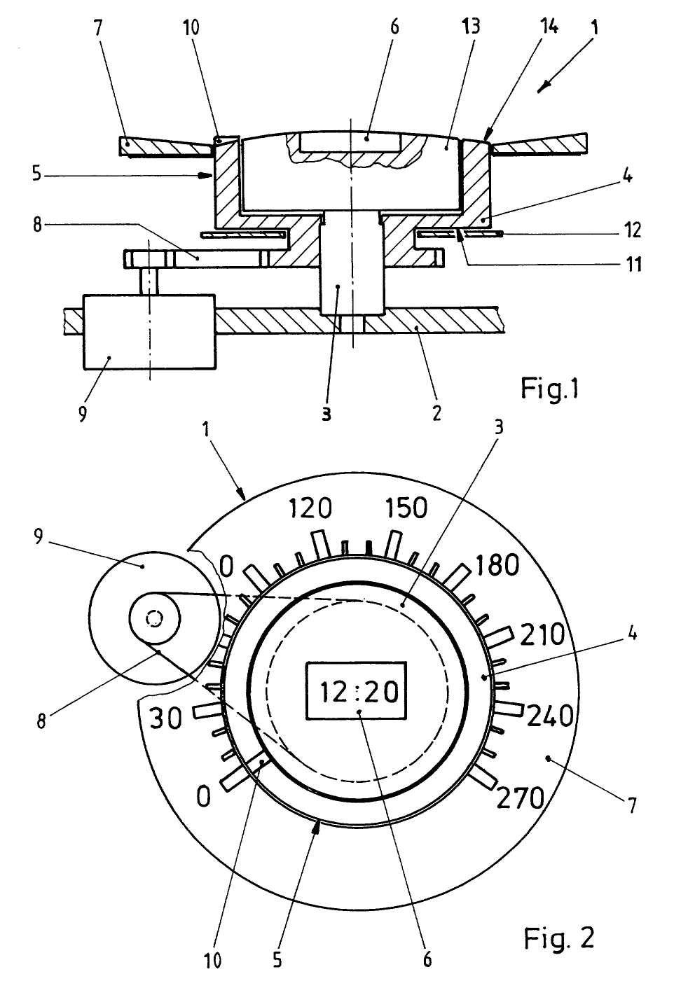

FIG. 1 shows a lateral, partly sectioned illustration of a pointer instrument according to the invention,

FIG. 2 shows a plan view of the pointer instrument.

FIG. 1 shows a lateral sectional illustration of a pointer instrument 1 having a tachometer. The pointer instrument has an axle 3 which is arranged centrally and is fixedly connected to a rear load bearing plate 2 designed, for example, as a printed circuit board of a combination instrument in a motor vehicle. A pointer 5 provided with a load-bearing body 4 is arranged so that it can rotate about this axle 3. The pointer 5 is of essentially pot-like design and, at its end inclined toward a viewer, encloses a widening 13 of the axle 3, this widening 13 bearing a central display 6 designed as a liquid crystal display. Arranged on the outside, adjacent to the pointer and in a plane which is essentially common with a viewing face 14 of the pointer 5, is a dial 7. The pointer 5 is connected by means of a belt drive 8 to a pointer drive 9, which permits the vibration-free deflection of the pointer 5 having a marking 10 which can be illuminated. Furthermore, the load-bearing body 4 has a light-injection face 11 which is arranged at right angles to the axle 3 and is arranged at a short distance from a light source designed as an electroluminescent sheet 12. The light streaming into the load-bearing body 4, designed as a light conductor, passes to the marking 10 and thus permits good legibility of the value displayed. As a result of the pot-like configuration of the load-bearing body 4, the light-injection face 11 on its underside can be designed to have a comparatively large area, so that uniform illumination can be provided. Other embodiments, in which the load-bearing body 4 is of essentially tubular design, and in which the pointer drive 9 engages on the load-bearing body 4 on the inside are likewise possible.

FIG. 2 shows a plan view of the pointer instrument 1 with the pointer 5 and the dial 7 adjacent thereto. It is possible to see the display 6, which is arranged centrally on the axle 3 and is designed as an LC display. Able to pivot about this axle 3 is the annular load-bearing body 4 having a marking 10 which identifies the pointer position and which, in the rest position illustrated, rests at only a short distance from the zero position of the dial 7. The pointer drive 9 arranged underneath the dial 7 can be seen in a cut-open section of the dial 7. The pointer 5 can be deflected by the pointer drive 9 by means of the belt drive 8, which prevents any transmission of external shaking or vibrations to the pointer 5.

In addition to the display 6 illustrated, further components, for example warning lights, but also further pointer instruments, can also be arranged on the axle 3. Another configuration of the pointer, in which the pointer instrument has a scaling that can be pivoted by means of the load-bearing body and has a fixed mark or pointer flag, are likewise possible.

1. A pointer instrument, especially for a motor vehicle, having a pointer, a pointer drive for deflecting the pointer and having a dial, it being possible for measured values to be displayed in analog fashion on the dial, wherein the pointer (5) can pivot about a fixed axle (3) which, on a section inclined toward a viewer, bears a display (6).

2. The pointer instrument as claimed in claim 1, wherein the display (6) is a liquid crystal display (LCD).

3. The pointer instrument as claimed in claim 1 or 2, wherein the pointer (5) has a rotationally symmetrical load-bearing body (4) which can pivot about the axle (3).

4. The pointer instrument as claimed in one of the preceding claims, wherein the axle (3) has a smaller diameter in a section that cannot be seen by the viewer than in a section (widening 13) which can be seen by the viewer.

5. The pointer instrument as claimed in one of the preceding claims, wherein the load-bearing body (4) has a light-injection face (11) on its side facing away from a viewer.

6. The pointer instrument as claimed in one of the preceding claims, wherein the pointer (5) and the dial (7) are arranged in a common plane.

7. The pointer instrument as claimed in one of the preceding claims, wherein the pointer instrument (1) can be illuminated by means of an electroluminescent sheet (12).

8. The pointer instrument as claimed in one of the preceding claims, wherein the pointer (5) can be deflected by the pointer drive (9) by means of a belt drive (8).

9. The pointer instrument as claimed in one of the preceding claims, wherein the pointer drive (9) is arranged laterally alongside the pointer (5).
